(19) United States
(12) Patent Application Publication
(10) Pub. No.: US 2026/0292637 A1
(43) Pub. Date: Sep. 24, 2026

(54) METHODS OF A DUAL ACTIVE PROTOCOL STACK (DAPS) HANDOVER OF A UE BETWEEN A SERVING CELL AND A TARGET CELL IN A NON-TERRESTRIAL NETWORK

(71) Applicant: Apple Inc., Cupertino, CA (US)

(72) Inventors: Jie Cui, San Jose, CA (US); Seyed Ali Akbar Fakoorian, San Diego, CA (US); Yang Tang, San Jose, CA (US); Dawei Zhang, Saratoga, CA (US); Qiming Li, Beijing (CN); Chunxuan Ye, San Diego, CA (US)

(21) Appl. No.: 19/472,460

(22) PCT Filed: Apr. 4, 2023
(86) PCT No.: PCT/CN2023/086190

§ 371 Date: Oct. 3, 2025

(51) Int. Cl. H04W 36/18; H04B 7/185; H04B 7/19; H04W 36/00

(52) U.S. Cl. CPC H04W 36/185; H04B 7/18541; H04B 7/19; H04W 36/0058; H04W 36/008355

(57) ABSTRACT

A network device including a transceiver operable to receive data from a user equipment (UE) and a processor is disclosed. The processor is configured to identify a set of one or more target network devices in a non-terrestrial network (NTN). The set of one or more target network devices is within a predetermined proximity to a serving network device of the UE in the NTN. The processor is configured to determine a set of one or more characteristics of the set of one or more target network devices and the serving network device, and in accordance with the set of one or more characteristics of the set of one or more target network devices and the service network device, configure a dual active protocol stack (DAPS) handover of the UE between the serving network device and a target network device of the set of one or more target network devices.

### TECHNICAL FIELD

This application relates generally to wireless communication systems, and in particular soft handover (or a dual active protocol stack (DAPS) handover) of a user equipment, between a serving cell in a non-terrestrial network (NTN) and a target cell in an NTN.

### BACKGROUND

Wireless mobile communication technology uses various standards and protocols to transmit data between a network device (e.g., a base station, a network access point, or a relay) and a wireless communication device (e.g., a user equipment (UE)). Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device (e.g., a base station, a network access point, or a relay) of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device (e.g., a base station, a network access point, or a relay) used by a RAN may correspond to that RAN. One example of the network device may be an E-UTRAN base station, which is an Evolved Universal Terrestrial Radio Access Network (E-UTRAN) Node B (also commonly denoted as evolved Node B, enhanced Node B, eNodeB, or eNB). Another example of the network device may be an NG-RAN base station, which is a next generation Node B (also sometimes referred to as a gNodeB or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows a communication system including a user equipment in communication with multiple network devices.

FIG. 2 shows an example method performed by a network device for performing a dual active protocol stack (DAPS) handover of a user equipment (UE), in accordance with some embodiments.

FIG. 3 shows another example method performed by a network device for performing a DAPS handover of a UE, in accordance with some embodiments.

FIG. 4 shows an example method performed by a UE for a DAPS handover of the UE, in accordance with some embodiments.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a network device and/or a user equipment (UE). However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device. Similarly, various embodiments are described with regard to a network device, which may be a network access point, a base station, and/or a relay deployed in a terrestrial network (TN), a satellite, and/or a high-altitude platform system (HAPS) including manned or unmanned aerial vehicles, and so on.

Various embodiments in the present disclosure describe a cell selection procedure for a soft handover of a user equipment (UE), which is also referenced herein as a dual active protocol stack (DAPS) handover, from a serving cell to a target cell. The serving cell and the target cell are both in a non-terrestrial network (NTN), such as a satellite system or a high-altitude platform system (HAPS). A DAPS handover of the UE, as described in 3GPP TS 38.133, is based on a UE capability, but ignores the propagation delay difference of a serving cell, for example, based on a satellite in which a serving network device is deployed, and a target cell, for example, based on a satellite in which a target network device is deployed. The embodiments described herein addresses these issues and provide a solution for a DAPS handover of the UE to a proper target cell.

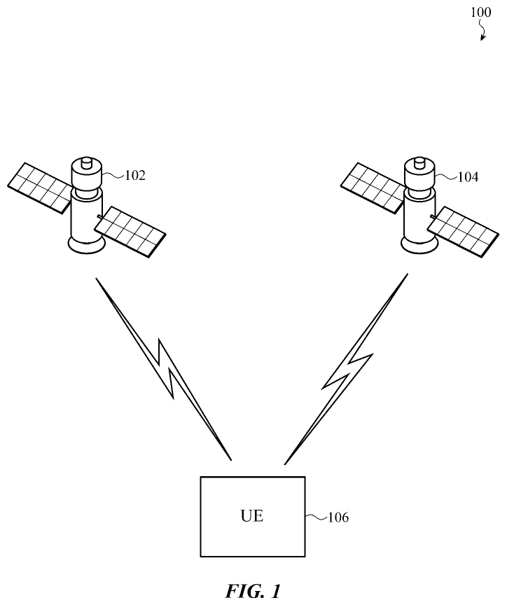

FIG. 1 shows a communication system including a user equipment in communication with multiple network devices. A communication system 100 shown in FIG. 1 includes a UE 106 and network devices 102 and 104. The UE 106 may be in communication with the network device 102. The network device 102 may be positioned in a satellite, which may be a satellite orbiting in a geosynchronous orbit (GSO). Accordingly, a serving cell of the UE 106 may be a GSO type based on a type of a satellite, in which the network device 102 is positioned, being a GSO satellite. Since the network device 102 is continuously moving, the UE may need to be handed over to another network device, for example, the network device 104, which may be positioned in a satellite, which may be a satellite orbiting in a GSO. Accordingly, a target cell of the UE 106 may be a GSO type based on the type of a satellite, in which the network device 104 is positioned, being a GSO satellite. Alternatively, or additionally, the serving cell or the target cell may be of a non-GSO (N-GSO) type.

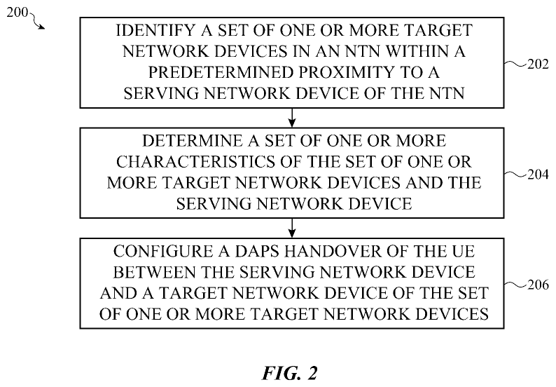

FIG. 2 shows an example method performed by a network device for performing a dual active protocol stack (DAPS) handover of a user equipment (UE), in accordance with some embodiments. As shown in a flow-chart 200, at 202, a network device may identify a set of one or more target network devices, which network devices may be in a non-terrestrial network (NTN) and/or a high-altitude platform system (HAPS). The network device may determine or identify the set of one or more target network devices based on a criterion, for example, a proximity to a serving cell or a serving network device of the UE. The proximity of a network device in the set of one or more network devices to the serving network device may be predetermined and/or a fixed.

At 204, the network device may determine or identify a set of one more characteristics of each target network device of the set of one or more target network devices. Additionally, or alternatively, the network device may determine or identify the set of one or more characteristics for a subset of the set of one or more target network devices. By way of a non-limiting example, the set of one or more characteristics may include a type of the serving network device and a type corresponding to each target network device of the set of one or more target network devices. As described herein, the type of the serving network device and/or the type of each target network device of the set of one or more target network devices may be a GSO, a N-GSO, and so on, depending on whether the serving or target network device is located in a satellite orbiting in a GSO, a N-GSO, and so on.

Additionally, or alternatively, the set of one or more characteristics may further include one or more characteristics identifying a proximity of the serving network device in the serving cell to each target network device (or a subset of target network devices) of the set of one or more target network devices in a respective target cell. The one or more characteristics identifying the proximity may include a respective (physical) distance difference between the serving network device and each target network device of the set of one or more target network devices, a respective receive time difference (RTD) of the UE corresponding to the serving network device and each target network device of the set of one or more target network devices, a respective round trip time (RTT) of the UE corresponding to the serving network device and each target network device of the set of one or more target network devices, and/or a respective absolute distance difference of the UE corresponding to the serving network device and each target network device of the set of one or more target network devices. By way of a non-limiting example, the one or more characteristics identifying a proximity of the serving network device in the serving cell to each target network device (or a subset of target network devices) of the set of one or more target network devices in a respective target cell may be determined based on ephemeris information corresponding to the serving network device and the set of one or more target network devices, and/or data received at the network device from the UE, which data may include a global navigation satellite system (GNSS) position data of the UE.

At 206, the network device may configure a DAPS handover of the UE between the serving network device and a target network device of the set of one or more target network devices in accordance with the set of one or more characteristics of the set of one or more target network devices and the service network device identified at 204.

By way of a non-limiting example, in some embodiments, a characteristic of the set of one or more characteristics based on which the DAPS handover of the UE is configured may be at least a type of the serving network device and a respective type of each target network device (or a subset of target network devices) of the set of one or more target network devices. Accordingly, the network device may configure the DAPS handover of the UE if a type of the serving network device is same as a type of a target network device of the set of one or more target network devices. In other words, the network device may configure the DAPS handover between a serving network device of a type GSO (or GSO type) to a target network device of a type GSO, or a service network device of a type N-GSO (or N-GSO type) to a target network device of a type N-GSO. Additionally, or alternatively, the network device may configure the DAPS handover of the serving network device of a type GSO to a target network device of any other type (e.g., a GSO type, a N-GSO type). Additionally, or alternatively, the network device may configure the DAPS handover of the serving network device of any type (e.g., a GSO type, a N-GSO type) to a target network device of a type GSO.

By way of a non-limiting example, in some embodiments, a characteristic of the set of one or more characteristics based on which the DAPS handover of the UE is configured may be at least a proximity of the serving network device in the serving cell to each target network device (or a subset of target network devices) of the set of one or more target network devices in a respective target cell. Accordingly, the network device may configure the DAPS handover of the UE from the serving network device to a target network device if a respective (physical) distance difference between the serving network device and a target network device of the set of one or more target network devices meets a particular criterion (e.g., a physical distance that is below a particular threshold value). Additionally, or alternatively, the network device may configure the DAPS handover of the UE from the serving network device to a target network device if a respective receive time difference (RTD) of the UE corresponding to the serving network device and the target network device of the set of one or more target network devices meets a particular criterion (e.g., a RTD that is close to 0), or if a respective round trip time (RTT) of the UE corresponding to the serving network device and the target network device of the set of one or more target network devices meets a particular criterion (e.g., a RTT that is smallest or close to 0), or if a respective absolute distance difference of the UE corresponding to the serving network device and the target network device of the set of one or more target network devices meets a particular criterion (e.g., an absolute distance difference that is close to 0).

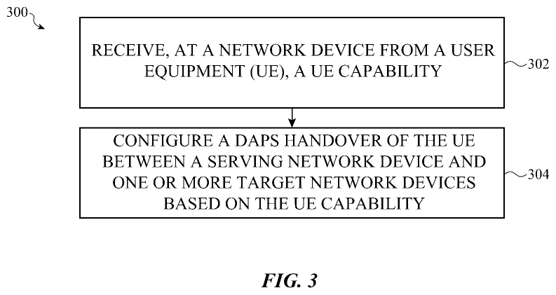

FIG. 3 shows another example method performed by a network device for performing a DAPS handover of a UE, in accordance with some embodiments. In particular, a flow-chart 300 shown in FIG. 3 corresponds to configuring a UE for a DAPS handover by a network device based on a UE capability received at the network device. As shown in the flow-chart 300, at 302, a network device may receive from a UE, a UE capability. The UE capability may include a count of different target network devices in one or more different target cells for which the UE supports simultaneous measurements within a synchronization signal block measurement and timing configuration (SMTC), which is described in 3GPP TS 38.306 as maxNumber-NGSO-Satellites WithinOneSMTC-r17. Additionally, or alternatively, the UE capability may include an indication of whether the UE supports measurements in parallel with an uplink (UL) transmission, a downlink (DL) transmission, or a radio resource management (RRM) measurement operation of the UE on a serving cell in which a serving network device of the UE is located and one or more different target cells in which one or more target network devices are located, which is described in 3GPP TS 38.306 as parallelMeasurement WithoutRestriction-r17.

At 304, based on the UE capability received at the network device, the network device may configure the UE for a DSPS handover between the serving network device and the one or more target network devices. For example, if a value of the maxNumber-NGSO-Satellites WithinOneSMTC-r17 is at least n2 (means 2) or above and/or if a value of the parallelMeasurement WithoutRestriction-r17 is true, the network device may configure the DAPS handover between the serving network device and a target network device operating on the same frequency range or the same frequency band or the same frequency carrier. The serving network device and the target network device may be of the same type or a different type. In other words, the serving network device and the target network device each may be of a type GSO or each may be of a type N-GSO, or the serving network device may be of a type GSO and the target network device may be of a type N-GSO, or the serving network device may be of a type N-GSO and the target network device may be of a type GSO.

In some embodiments, and by way of a non-limiting example, the UE capability may further include an indication whether the UE supports inter-frequency DAPS handover (e.g., interFreqDAPS-NTN-r18) or intra-frequency DAPS handover (e.g., intraFreqDAPS-NTN-r18) between the serving network device and a target network device of the one or more target network devices. The UE supporting the inter-frequency DAPS handover may also support DL reception of a physical downlink shared channel (PDSCH) and/or a physical downlink control channel (PDCCH). Additionally, or alternatively, the UE supporting the inter-frequency DAPS handover and/or intra-frequency DAP handover may also support a single uplink (UL) transmission during the DAPS handover and/or canceling UL transmission to a source satellite during the DAPS handover.

Additionally, or alternatively, the UE capability may also include a combination of a type (e.g., a GSO type, a N-GSO type) of the serving network device and a type (e.g., a GSO type, a N-GSO type) of the at least one target network device of the one or more target network devices for which the network device can configure the DAPS handover of the UE. The network device, accordingly, may configure the DAPS handover of the UE based on the combination received in the UE capability.

In some embodiments, and by way of a non-limiting example, the UE capability may further include an indication whether the UE supports intra-frequency asynchronous DAPS handover (e.g., intraFreqAsyncDAPS-NTN-r18) and/or inter-frequency asynchronous DAPS handover (e.g., interFreqAsyncDAPS-NTN-r18) between the serving network device and a target network device of the one or more target network devices. The UE supporting the inter-frequency asynchronous DAPS handover and/or the intra-frequency asynchronous DAPS handover may also include in the UE capability a combination of a type (e.g., a GSO type, a N-GSO type) of the serving network device and a type (e.g., a GSO type, a N-GSO type) of the at least one target network device of the one or more target network devices for which the network device can configure the DAPS handover of the UE. The network device, accordingly, may configure the DAPS handover of the UE based on the combination received in the UE capability. The UE supporting asynchronous DAPS handover may also support synchronous DAPS handover, and vice versa.

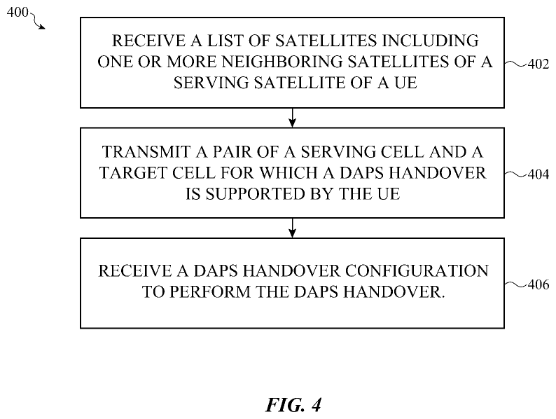

FIG. 4 shows an example method performed by a UE for a DAPS handover of the UE, in accordance with some embodiments. As shown in a flow-chart 400, at 402, a UE may receive from a network (e.g., a radio access network (RAN) or a core network (CN)) a list of satellites including one or more neighboring satellites of a serving satellite of the UE according to a criterion, which criterion may be, for example, a proximity between a serving network device (or the serving satellite of the UE) and a target network device (or a target satellite) identified using various aspects described herein. In other words, the list of satellites may include one or more target satellites with respect to which a UE may perform a DAPS handover and/or a current serving satellite of the UE may perform a DAPS handover.

At 404, the UE may transmit to the network a pair of a serving cell and a target cell for which the UE may support a DAPS handover. The target cell may be associated with a target satellite which is selected from the list of satellites received by the UE at 402. And, at 406, the UE may receive from the network a DAPS handover configuration to perform a DAPS handover. In some embodiments, by way of a non-limiting example, the UE may also transmit to the network an indication in response to determining that the DAPS handover cannot be performed between a current serving network device of the current serving cell and a target network device of the target cell to which the UE needs to perform a DAPS handover based on the DAPS configuration received at 406.

Embodiments contemplated herein include an apparatus having means to perform one or more elements of the method 200, 300, or 400. In the context of method 400, the apparatus may be, for example, an apparatus of a UE (such as a wireless device 602 that is a UE, as described herein). In the context of method 200 or 300, the apparatus may be, for example, an apparatus of a network device (such as a network device 620 that is a network access point or a base station, as described herein).

Embodiments contemplated herein include one or more non-transitory computer-readable media storing instructions to cause an electronic device, upon execution of the instructions by one or more processors of the electronic device, to perform one or more elements of the method 200, 300 or 400. In the context of method 400, the non-transitory computer-readable media may be, for example, a memory of a UE (such as a memory 606 of a wireless device 602 that is a UE, as described herein). In the context of method 200 or 300, the non-transitory computer-readable media may be, for example, a memory of a network device (such as a memory 624 of a network device 620 that is a network access point or a base station, as described herein).

Embodiments contemplated herein include an apparatus that has logic, modules, or circuitry to perform one or more elements of the method 200, 300 or 400. In the context of method 400, the apparatus may be, for example, an apparatus of a UE (such as a wireless device 602 that is a UE, as described herein). In the context of method 200 or 300, the apparatus may be, for example, an apparatus of a network device (such as a network device 620 that is a network access point or a base station, as described herein).

Embodiments contemplated herein include an apparatus having one or more processors and one or more computer-readable media, using, or storing instructions that, when executed by the one or more processors, cause the one or more processors to perform one or more elements of the method 200, 300 or 400. In the context of method 400, the apparatus may be, for example, an apparatus of a UE (such as a wireless device 602 that is a UE, as described herein). In the context of the method 200 or 300, the apparatus may be, for example, an apparatus of a network device (such as a network device 620 that is a network access point or a base station, as described herein).

Embodiments contemplated herein include a signal as described in or related to one or more elements of the method 200, 300 or 400.

Embodiments contemplated herein include a computer program or computer program product that has instructions, wherein execution of the program by a processor causes the processor to carry out one or more elements of the method 200, 300 or 400. In the context of method 400, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). In the context of method 200 or 300, the processor may be a processor of a network device (such as a processor(s) 622 of a network device 620 that is a network access point or a base station, as described herein), and the instructions may be, for example, located in the processor and/or on a memory of the network device (such as a memory 624 of a network device 620 that is a network access point or a base station, as described herein).

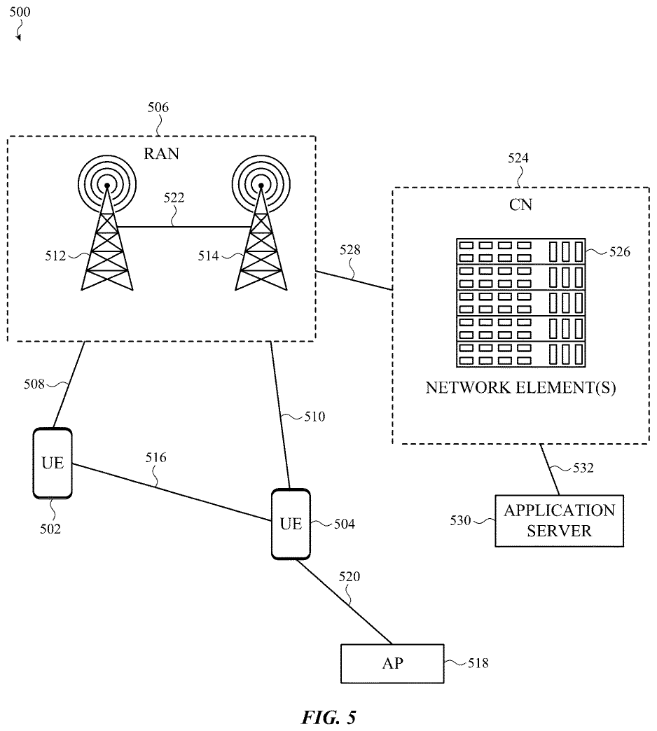

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, and so on. The UE 502 and UE 504 utilize connections (or channels) (shown as connection 508 and connection 510, respectively) with the RAN 506, each of which comprises a physical communications interface. The RAN 506 can include one or more base stations, such as base station 512 and base station 514, that enable the connection 508 and connection 510. In some embodiments, the RAN 506 may include one or more relays.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all, or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, and so on.) for the UE 502 and UE 504 via the CN 524. The application server 530 may communicate with the CN 524 through an IP communications interface 532.

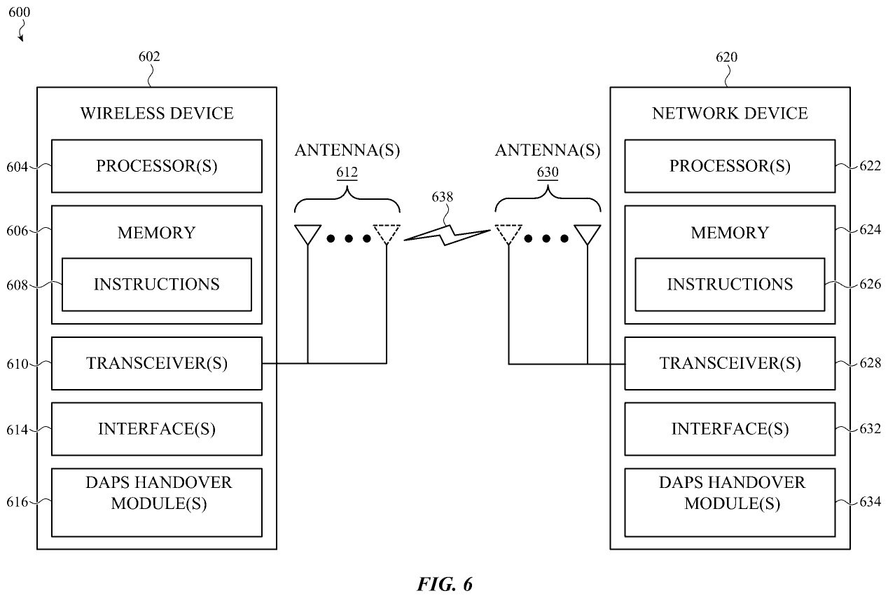

FIG. 6 illustrates a system 600 for performing signaling 638 between a wireless device 602 and a network device 620, according to embodiments disclosed herein. The system 600 may be a portion of a wireless communication system as herein described. The wireless device 602 may be, for example, a UE of a wireless communication system. The network device 620 may be, for example, a base station (e.g., an eNB or a gNB), or a relay of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 640) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments that have multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include one or more DAPS handover module(s) 616. The DAPS handover module(s) 616 may be implemented via hardware, software, or combinations thereof. For example, the DAPS handover module(s) 616 may be implemented as a processor, circuit, and/or instructions 608 stored in the memory 606 and executed by the processor(s) 604. In some examples, the DAPS handover module(s) 616 may be integrated within the processor(s) 604 and/or the transceiver(s) 610. For example, the DAPS handover module(s) 616 may be implemented by a combination of software components (e.g., executed by a DSP or a general processor) and hardware components (e.g., logic gates and circuitry) within the processor(s) 604 or the transceiver(s) 610.

The DAPS handover module(s) 616 may be used for various aspects of the present disclosure, for example, aspects of FIGS. 1-4, from a UE perspective.

The network device 620 may include one or more processor(s) 622. The processor(s) 622 may execute instructions such that various operations of the network device 620 are performed, as described herein. The processor(s) 604 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments that have multiple antenna(s) 630, the network device 620 may perform MIMO, digital beamforming, analog beamforming, beam steering, and so on, as has been described.

The network device 620 may include one or more interface(s) 632. The interface(s) 632 may be used to provide input to or output from the network device 620. For example, a network device 620 that is a base station may include interface(s) 632 made up of transmitters, receivers, and other circuitry (e.g., other than the transceiver(s) 628/antenna(s) 630 already described) that enables the base station to communicate with other equipment in a core network, and/or that enables the base station to communicate with external networks, computers, databases, and the like for purposes of operation, administration, and maintenance of the base station or other equipment operably connected thereto.

The network device 620 may include one or more DAPS handover module(s) 634. The DAPS handover module(s)) 634 may be implemented via hardware, software, or combinations thereof. For example, the DAPS handover module(s) 634 may be implemented as a processor, circuit, and/or instructions 626 stored in the memory 624 and executed by the processor(s) 622. In some examples, the DAPS handover module(s) 634 may be integrated within the processor(s) 622 and/or the transceiver(s) 628. For example, the DAPS handover module(s) 634 may be implemented by a combination of software components (e.g., executed by a DSP or a general processor) and hardware components (e.g., logic gates and circuitry) within the processor(s) 622 or the transceiver(s) 628.

The DAPS handover module(s) 634 may be used for various aspects of the present disclosure, for example, aspects of FIGS. 1-4, from a network device perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, and so on. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, and so on. of one embodiment can be used in another embodiment. The parameters, attributes, aspects, and so on. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
identify a set of one or more target network devices in a non-terrestrial network (NTN), the set of one or more target network devices within a predetermined proximity to a serving network device of a user equipment (UE) in the NTN;
determine a set of one or more characteristics of the set of one or more target network devices and the serving network device;
in accordance with the set of one or more characteristics of the set of one or more target network devices and the service network device, configure a dual active protocol stack (DAPS) handover of the UE between the serving network device and a target network device of the set of one or more target network devices.

2. The apparatus of claim 1, wherein:
the set of one or more characteristics including a type of the serving network device and a type corresponding to each target network device of the set of one or more target network devices.

3. The apparatus of claim 2, wherein the processor is further configured to configure the DAPS handover of the UE based at least in part on the serving network device and the target network device having a same type.

4. The apparatus of claim 2, wherein the processor is further configured to configure the DAPS handover of the UE based at least in part on the serving network device and the target network device having a same type of geosynchronous orbit (GSO) satellite.

5. The apparatus of claim 2, wherein:
the type of the serving network devices is a geosynchronous orbit (GSO) satellite; and
the processor is further configured to configure the DAPS handover of the UE having the serving network device of the type of GSO satellite to any type of the target network device.

6. The apparatus of claim 2, wherein:
the type of the target network device is a geosynchronous orbit (GSO) satellite; and
the processor is further configured to configure the DAPS handover of the UE to the target network device that is of the type GSO satellite from any time of the serving network device of the UE.

7. The apparatus of claim 1, wherein:
the data from the UE includes a global navigation satellite system (GNSS) position data of the UE;
the set of one or more characteristics further including at least one of:
a respective distance difference between the serving network device and the target network device of the set of one or more target network devices;
a respective receive time difference (RTD) of the UE corresponding to the serving network device and to the target network device of the set of one or more target network devices;
a respective round-trip time (RTT) of the UE corresponding to the serving network device and to the target network device of the set of one or more target network devices; or
a respective absolute distance difference of the UE corresponding to the serving network device and to the target network device of the set of one or more target network devices; and
the processor is further configured to configure the DAPS handover of the UE from the serving network device to the target network device of the set of one or more target network devices having the respective distance difference that meets a first particular criterion, the respective RTD that meets a second particular criterion, the respective RTT that meets a third particular criterion, or the respective absolute distance difference that meets a fourth particular criterion.

8. An apparatus comprising memory coupled to a processor, the processor configured to:
receive, from a user equipment (UE), a UE capability including a count of different target network devices in one or more different target cells for which the UE supports simultaneous measurements within a synchronization signal block measurement and timing configuration (SMTC), and whether the UE supports measurements in parallel with an uplink (UL) transmission, a downlink (DL) transmission, or a radio resource management (RRM) measurement operation of the UE on a serving cell in which a serving network device of the UE is located and one or more different target cells in which one or more target network devices are located; and
in accordance with the received UE capability, configure a dual active protocol stack (DAPS) handover of the UE between the serving network device and the one or more target network devices.

9. The apparatus of claim 8, wherein the processor is further configured to configure the DAPS handover of the UE between the service network device and a target network device of the one or more target network devices in response to the UE capability indicating the count of different target network devices in the one or more different target cells for which the UE supports simultaneous measurements with the SMTC is two or more.

10. The apparatus of claim 9, wherein each of the service network device and the target network device operates on the same frequency band or the same frequency range or the same frequency carrier.

11. The apparatus of claim 9, wherein:
the serving network device is located on a geosynchronous orbit satellite or a non-geosynchronous orbit satellite; and
the target network device is located on a geosynchronous orbit satellite or a non-geosynchronous orbit satellite.

12. The apparatus of claim 8, wherein the processor is further configured to configure the DAPS handover of the UE between the service network device and a target network device of the one or more target network devices in response to the UE capability indicating that the UE supports measurements in parallel with the UL transmission, the DL transmission, or the RRM measurement operation of the UE on the serving cell in which the serving network device of the UE is located and the one or more different target cells in which the one or more target network devices are located.

13. The apparatus of claim 12, wherein:
each of the service network device and the target network device operates on the same frequency band or the same frequency range or the same frequency carrier.

14. The apparatus of claim 12, wherein:
each of the serving network device and the target network device is located on a geosynchronous orbit satellite, or
each of the serving network device and the target network device is located on a non-geosynchronous orbit satellite.

15. The apparatus of claim 8, wherein:
the UE capability further includes,
whether the UE supports inter-frequency DAPS handover between the serving network device and a target network device of the one or more target network devices,
whether the UE supports intra-frequency DAPS handover between the serving network device and a target network device of the one or more target network devices, or
whether the UE supports asynchronous DAPS handover between the serving network device and the target network device of the one or more target network devices.

16. The apparatus of claim 15, wherein the processor is further configured to configure the DAPS handover of the UE between the serving network device and the at least one target network device of the one or more target network devices in response to the UE capability suggesting the UE supports the inter-frequency DAPS handover or the intra-frequency DAPS handover.

17. The apparatus of claim 16, wherein:
the UE capability further includes a combination of a type of the serving network device and a type of the at least one target network device of the one or more target network devices for which the network device can configure the DAPS handover of the UE; and
the processor is further configured to configure the DAPS handover of the UE based on the combination received in the UE capability.

18. The apparatus of claim 15, wherein:
the UE capability further includes a combination of a type of the serving network device and a type of the at least one target network device of the one or more target network devices for which the network device can configure the DAPS handover of the UE; and
the processor is further configured to:
configure the DAPS handover of the UE between the serving network device and the at least one target network device of the one or more target network devices based on the combination received in the UE capability corresponding to the asynchronous DAPS handover.

19. An apparatus comprising a memory coupled to a processor, the processor configured to:
receive, from a network, a list of satellites including one or more neighboring satellites of a serving satellite of a user equipment (UE) according to a criterion;
generate for transmission, to the network, a pair of a serving cell and a target cell for which a dual active protocol stack (DAPS) handover is supported by the UE, the target cell corresponds to a target satellite from the list of satellites; and
receive, from the network, a DAPS handover configuration to perform a DAPS handover.

20. The apparatus of claim 19, wherein the processor is further configured to generate for transmission, to the network, an indication in response to determining that the DAPS handover cannot be performed between a serving network device of the serving cell and a target network device of the target cell.
